(19) United States
(12) Patent Application Publication
(10) Pub. No.: US 2009/0133980 A1
(43) Pub. Date: May 28, 2009

(54) Torque-Limiting Connector

(76) Inventors: Jason A. Swaim, Castle Rock, CO (US); James E. Cannon, Black Forest, CO (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/946,189

(22) Filed: Nov. 28, 2007

(51) Int. Cl. F16D 43/20

(52) U.S. Cl. 192/45.1

(57) ABSTRACT

A torque-limiting connector includes an outer clutch having a plurality of biased outer teeth and an inner clutch configured to fit within the outer clutch, the inner clutch having a plurality of cantilevered inner members. Each of the plurality of cantilevered inner members has an inner tooth, wherein upon the application of a predetermined amount of torque, each of the plurality of biased outer teeth slips over a respective inner tooth.

### BACKGROUND

Test and instrumentation devices, such as spectrum analyzers, single capture and sampling oscilloscopes, and other RF/microwave instruments, typically use high performance connectors to connect the devices to signal sources, probes, etc. Typically, the user of the device must attach these connectors to the front or rear panel of the device. These connectors are typically threaded, since this leads to a reliable, repeatable mating connection that yields good mechanical attachment and good electrical performance. Threaded connectors, however, must be tightened with a predetermined amount of torque to provide consistent measurement results from measurement to measurement. Properly tightening these connections typically requires the use of a torque wrench, or another torque-limiting tool, to provide the proper amount of tightening force on the connector. Unfortunately, a torque wrench is expensive, can be complicated to use properly, must be periodically tested and calibrated, and may become lost over time.

Furthermore, as test and instrumentation devices become capable of faster measurements and higher frequency performance, the associated connectors will be expected to exhibit similar higher performance electrical and mechanical capabilities. Further still, a customer that may purchase such test and measurement devices may be unfamiliar with the proper manner in which to connect and tighten such new high-performance connectors. An uninformed user may employ a non-specialized tool or conventional wrench to tighten such a connector. In addition to applying an improper amount of tightening force, a non-specialized tool or conventional wrench can also damage the connector.

Therefore, it would be desirable to have a way to reliably and consistently tighten a connector to a specified torque value without a specialized tool.

### SUMMARY

In accordance with an embodiment, a torque-limiting connector includes an outer clutch having a plurality of biased outer teeth and an inner clutch configured to fit within the outer clutch, the inner clutch having a plurality of cantilevered inner members. Each of the plurality of cantilevered inner members has an inner tooth, wherein upon the application of a predetermined amount of torque, each of the plurality of biased outer teeth slips over a respective inner tooth.

Other embodiments and methods of the invention will be discussed with reference to the figures and to the detailed description.

### BRIEF DESCRIPTION OF THE FIGURES

The invention will be described by way of example, in the description of exemplary embodiments, with particular reference to the accompanying figures.

FIG. 1 is a schematic diagram illustrating a torque-limiting connector.

FIG. 2 is a schematic diagram illustrating a cross-sectional view of the torque-limiting connector of FIG. 1.

FIG. 3 is a schematic view illustrating the outer clutch of FIG. 1.

FIG. 4 is a schematic view illustrating the inner clutch of FIG. 1.

FIG. 5 is a schematic view illustrating the reverse side of the outer clutch of FIG. 1.

FIG. 6 is a schematic view illustrating a perspective view of the reverse side of the outer clutch of FIG. 5.

FIG. 7 is an assembly view of the torque-limiting connector of FIG. 1.

FIG. 8 is a flowchart describing the operation of an embodiment of the torque-limiting connector of FIG. 1.

FIG. 9 is a plan view of the outer clutch, including exemplary dimensions.

FIG. 10 is a plan view of the inner clutch, including exemplary dimensions.

FIG. 11 is a profile view of the torque-limiting connector including a connector nut installed within the inner clutch.

### DETAILED DESCRIPTION

While described below as being applicable to a radio frequency (RF) connector for use on a test and measurement device, the torque-limiting connector can be used in any application in which it is desirable to form a positive, reliable and consistent mechanical and electrical connection.

Using a torque-limiting, or torque override mechanism, ensures that a consistent and specified amount of torque can be applied to a connector, such as an RF connector, without the use of external or specialized tools or complicated instructions. In addition, the torque-limiting connector to be described below eliminates surfaces on the connector, typically referred to as the “wrench flats” to which a conventional tool or wrench may be applied. This reduces the likelihood that a user will use a conventional wrench or pliers to fasten the connector. Further, high performance RF connectors are precision machined and easily damaged by tools, particularly by tools that are incorrectly or improperly used. The torque-limiting connector is relatively simple and comprises two primary components. The components can be inexpensively produced by, for example, molding, and can be deployed or modified for a variety of test and measurement instruments using a threaded or bayonet-style connector. The torque-limiting connector can be used with a standard connector, and can easily be retrofitted to fit existing instruments and connectors.

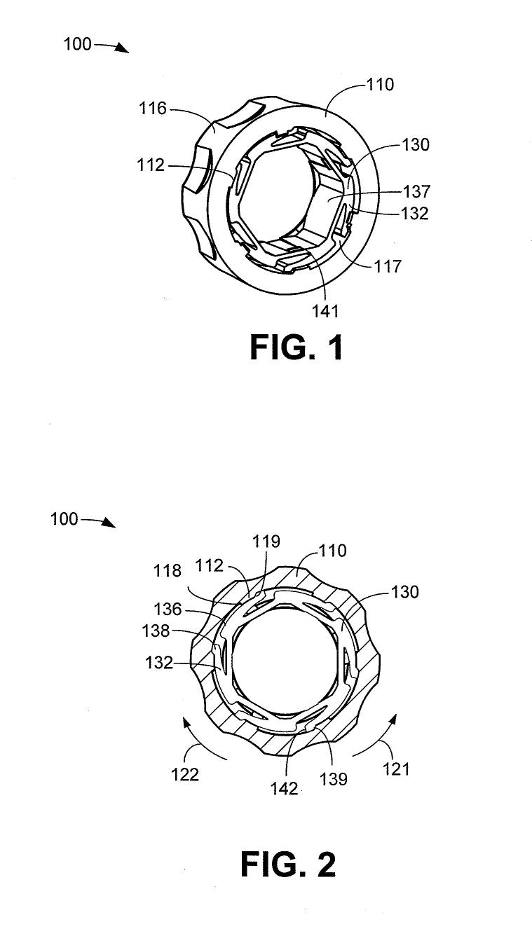

FIG. 1 is a schematic diagram illustrating a torque-limiting connector. The torque-limiting connector 100 includes an outer clutch 110 and an inner clutch 130. The outer clutch 110 has an outer surface 116 and an inner surface 117. The outer surface 116 can be textured, or knurled, so that a gripping surface is created. The outer clutch 110 freely rotates around the inner clutch 130 in at least one direction. The inner surface 117 includes a plurality of biased outer teeth 112. The biased outer teeth 112 are radially oriented around the circumference of the inner surface 117. The biased outer teeth 112 can be evenly or unevenly spaced, depending on application. Each biased outer tooth 112 includes a drive side and a slip side, which will be described in detail below.

The inner clutch 130 has a plurality of cantilevered inner members 132. The cantilevered inner members 132 are radially oriented around the circumference of an outer surface (136 in FIG. 2 and FIG. 4). The cantilevered inner members 132 can be evenly or unevenly spaced, depending on application. Typically, the number of cantilevered inner members 132 corresponds to the number of biased outer teeth 112 on the outer clutch 110.

The inner clutch 130 includes at least one flange 141 on an inner surface 137. The flange 141 allows a connector nut (not shown) to be releasably installed within the inner clutch 130. Alternatively, the flange 141 may also be configured to allow a connector nut (not shown) to be permanently or removably installed within the inner clutch 130. Such a connector nut is not part of the torque-limiting connector 100, but would be installed within the inner clutch 130 during use of the torque-limiting connector 100.

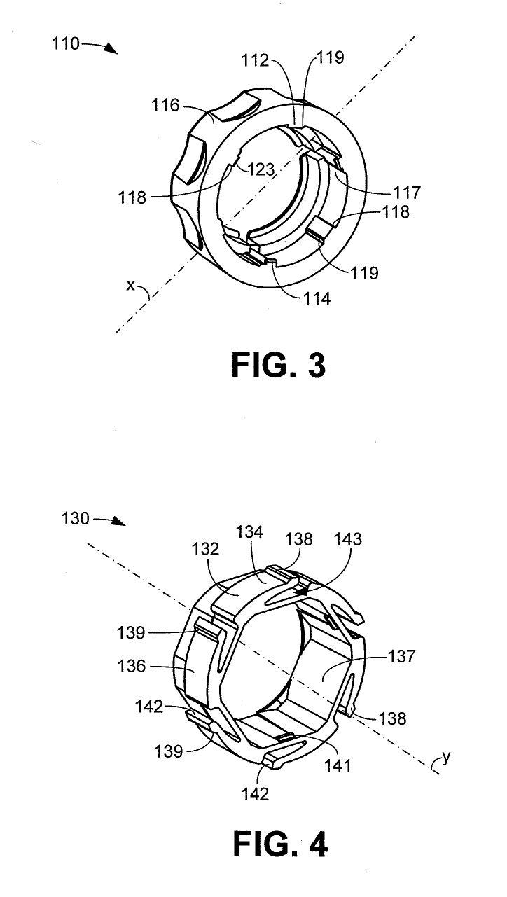

FIG. 2 is a schematic diagram illustrating a cross-sectional view of the torque-limiting connector 100 of FIG. 1. Each biased outer tooth 112 includes a drive side 118, a slip side 119 and a flat surface 123 (FIG. 3). The slip side 119 is slanted, or angled, with respect to the drive side 118. Each cantilevered inner member 132 includes an inner tooth 138. Each inner tooth 138 includes a drive side 142 and a slip side 139. The slip side 139 is slanted, or angled, with respect to the drive side 142. A lock direction is shown using the arrow 121 and a slip direction is shown using the arrow 122. The inner clutch 130 is installed within the outer clutch 110 so that at least a portion of the inner surface 117 of the outer clutch 110 contacts at least a portion of the outer surface 136 of the inner clutch 130. The contact between the inner surface 117 (FIG. 1) of the outer clutch 110 and the outer surface 136 of the inner clutch 130 provides a friction fit so that the outer clutch 110 and the inner clutch 130 can be moved in the same direction, and at least slightly in opposite directions. The movement of the inner clutch 130 and outer clutch 110 in opposite directions is also referred to as “backlash.” The amount of backlash can be controlled by the number of cantilevered inner members 132. For example, when tightening the torque-limiting connector 100, the outer clutch 110 is rotated in the direction of arrow 122. This causes the outer clutch 110 to rotate around the outer surface 136 of the inner clutch 130 until the slip side 119 of each biased outer tooth 112 contacts the slip side 139 of each inner tooth 138. This contact causes the inner clutch 130 to also rotate in the direction of the arrow 122, thus tightening a connector nut (not shown) onto its connection.

FIG. 3 is a schematic view illustrating the outer clutch 110. The inner surface 117 includes a plurality of biased outer teeth 112. At least one of the biased outer teeth 112 is provided with a locking feature 114. The locking feature 114 allows the inner clutch 130 (FIG. 1 and FIG. 2) to be releasably installed within the outer clutch 110, so that the outer clutch 110 and the inner clutch 130 form a unitary member in the axis through the assembly, shown in FIG. 3 as axis “x.” The inner clutch 130 and the outer clutch 110 may freely rotate with respect to one another, until the drive side 142 of the inner teeth 138 contact the drive side 118 of the biased outer teeth 112. The locking feature 114 is operative to prevent unintentional separation of the inner clutch 130 and the outer clutch 110. However, with the application of sufficient pressure to the locking feature 114, the inner clutch 130 can be separated from the outer clutch 110 without destroying either clutch. The effort needed to separate the inner clutch 130 from the outer clutch 110 can be adjustable.

FIG. 4 is a schematic view illustrating the inner clutch 130 of FIG. 1. Each cantilevered inner member 132 includes an inner tooth 138 and a flexible portion 134. The inner tooth 138 is located on an end of the flexible portion 134. The inner tooth 138 includes a slip side 139 and a drive side 142. The inner clutch 130 can be fabricated from a robust, deformable plastic, a resin, or other material. An example of a robust, deformable material is nylon or DELRIN, which is a registered trademark of the Dupont Corporation. Fabricating the inner clutch 130 from a robust, deformable material allows the flexible portion 134 to withstand many deformation cycles without mechanical failure. In an embodiment, the inner clutch 130 comprises six cantilevered inner members 132. However, the number of cantilevered inner members 132 is arbitrary and should be determined based upon application. The nominal torque of the inner clutch 130 and the outer clutch 110 can be adjusted by changing the depth of the cantilevered inner members 132 (along the axis, y). The relationship between the dimension of the cantilevered inner member 132 along the y axis and the amount of torque applied by the inner clutch 130 is linear. For example, halving the dimension of the cantilevered inner member 132 along the y axis will halve the torque applied by the inner clutch 130.

When a force is applied in an inward direction, for example, when the slip side 119 of a biased outer tooth 112 begins to slip against the slip side 139 of an inner tooth 138, the cantilevered inner members 132 undergo inward radial deflection. The amount of flex in the flexible portion 134 defines an amount of force needed to deflect the flexible portion 134. The flexibility of the flexible portion 134 can be defined by the material from which the flexible portion 134 is fabricated, the profile of the flexible portion 134, the slope formed by the flexible portion 134, the shape and size of an undercut 143 below the flexible portion 134, and other factors. The degree of flexibility of the flexible portion 134 determines the amount of torque that will be applied to the inner clutch 130 by the outer clutch 110 and hence, to a connector nut installed within the inner clutch 130.

Referring back to FIG. 2, when tightening the torque-limiting connector 100, the outer clutch 110 is rotated in the direction of arrow 122. This causes the outer clutch 110 to rotate around the outer surface 136 of the inner clutch 130 until the slip side 119 of each biased outer tooth 112 contacts the slip side 139 of each inner tooth 138. The rigidity of the flexible portion 134 of the cantilevered inner member 132 allows the slip side 119 of each biased outer tooth 112 to bear against the slip side 139 of each inner tooth 138. This contact causes the inner clutch 130 to also rotate in the direction of the arrow 122, thus tightening a connector nut (not shown) installed within the inner clutch 130 onto its mating connection. However, when the amount of force applied by the slip side 119 of each biased outer tooth 112 against the slip side 139 of each inner tooth 138 overcomes the rigidity of the flexible portion 134 of each cantilevered inner member 132, the flexible portion 134 begins to deflect radially inward with respect to the inner clutch 130.

When the flexible portion 134 begins to deflect, the slip side 119 of each biased outer tooth 112 begins to slide, or slip against the slip side 139 of each inner tooth 138. When the outer clutch 110 is advanced radially in clockwise direction against the inner clutch 130, this force will eventually overcome the rigidity of the flexible portion 134 and the outer clutch 110 will rotate about the inner clutch 130, but will apply no further twisting force to the inner clutch 130. In this mode of operation, the slip side 139 of the inner tooth 138 is no longer riding against the slip side 119 of the biased outer tooth 112. Instead, the slip side 139 of the inner tooth 138 rides against the flat surface 123 of the biased outer tooth 112. Because of this somewhat drastic change in contact angle between the inner tooth 138 and the biased outer tooth 112, there is significantly less load transfer and torque applied from the outer clutch 110 to the inner clutch 130. This occurs because upon sufficient force, the flexible portions 134 of each cantilevered inner member 132 deflect to a point at which the slip side 119 of each biased outer tooth 112 will slide over the slip side 139 of each inner tooth 138, thus limiting the amount of torque applied to the inner clutch 130. In this manner, by carefully designing the flexible portion 134 of each cantilevered inner member 132, a precise amount of torque can be applied from the outer clutch 110 to the inner clutch 130, thus preventing over-torqueing of a connector associated with the torque-limiting connector 100. The degree of flexibility of the flexible portion 134 determines a predetermined amount of torque that can be applied from the outer clutch 110 to the inner clutch 130.

Further, when the slip side 119 of each biased outer tooth 112 slides over the slip side 139 of each inner tooth 138 and the inner tooth 138 snaps back to its original position, a clicking noise is created, thus alerting a user that a solid connection has been made, and that the correct torque value has been reached. In this manner, a consistent and repeatable tightening force can be applied to a connector nut. The intensity and feel of the audible click can be determined by material choice and by the number of cantilevered inner members 132. Further, based on material and dimensions, the audible clicking noise can be determined independently of the torque value.

When removing the connector, the outer clutch 110 is turned in the direction of the arrow 121 (FIG. 2). Turning the outer clutch 110 in the direction of the arrow 121 causes the inner surface 117 of the outer clutch 110 to rotate around the outer surface 136 of the inner clutch 130. The outer clutch 110 will rotate around the inner clutch 130 until the drive side 118 of the biased outer tooth 112 encounters the drive side 142 of the inner tooth 138. When the drive side 118 of the biased outer tooth 112 encounters the drive side 142 of the inner tooth 138 relative movement between the outer clutch 110 and the inner clutch 130 is prevented and twisting force is applied from the outer clutch 110 to the inner clutch 130. Because the drive side 118 of the biased outer tooth 112 encounters the drive side 142 of the inner tooth 138, and because the flexible portion 134 will not deflect when force is applied to the inner clutch 130 in the direction shown by arrow 121, the outer clutch 110 will turn the inner clutch 130, thus causing the connector nut (not shown) within the inner clutch 130 to be loosened from its mating surface. The description of tightening and loosening provided in this description assumes right-hand threaded connectors. However, the torque-limiting connector 100 is also applicable to left-hand threaded connections.

In an embodiment, the drive side 118 of the biased outer tooth 112 and the drive side 142 of the inner tooth 1381 meet parallel to the radius of the torque-limiting connector 100. However, the drive side 118 of the biased outer tooth 112 and the drive side 142 of the inner tooth 138 can be biased inward to achieve additional locking power. In this manner, the torque-limited connector 100 can be used to install a connector using a predetermined amount of force, and can be used to disconnect the connector by applying as much force as necessary to loosen the connector nut. The radial arrangement described above is particularly useful for applying a controlled amount of torque to tighten a fastener having an axis of rotation through the center of the connector.

In an alternative application, the torque-limiting connector 100 can be implemented as a separate tool that can be adapted to fit over an existing nut or connector element. In this manner, the hexagonal outer surface of the nut, which is not easily gripped by a human hand, can be converted into a human-usable shape. The torque-limiting connector 100 is also applicable to connectors with more or fewer than six sides.

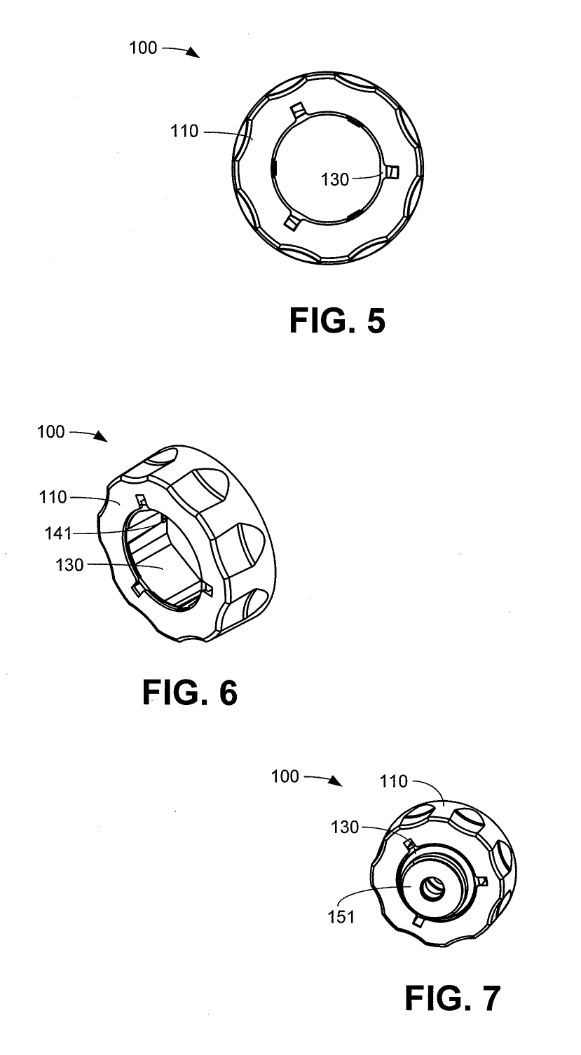

FIG. 5 is a schematic view illustrating the reverse side of the outer clutch of FIG. 1. The outer clutch 110 is shown as engaging the inner clutch 130. The locking feature 114 (FIG. 3) prevents the inner clutch 130 from unintentionally separating from the outer clutch 110.

FIG. 6 is a schematic view illustrating a perspective view of the reverse side of the outer clutch of FIG. 5. The outer clutch 110 is shown as engaging the inner clutch 130. The flange 141 of the inner clutch 130 is also shown.

FIG. 7 is an assembly view of the torque-limiting connector of FIG. 1. A connector nut 151 is shown engaged within the inner clutch 130. When the inner clutch 130 rotates the connector nut 151 is coupled to its mating connector (not shown).

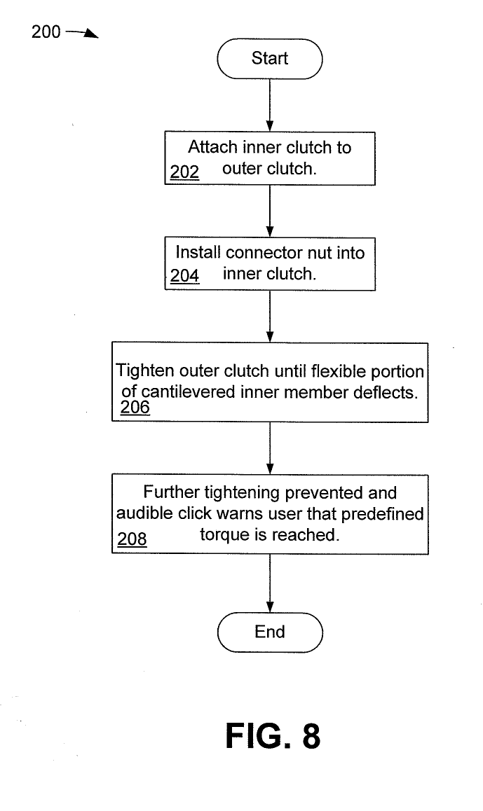

FIG. 8 is a flowchart 200 describing the operation of an embodiment of the torque-limiting connector of FIG. 1. The functions associated with respective blocks can be performed in or out of the order shown, and are presented in the order for ease of description. In block 202, the inner clutch 130 is attached to the outer clutch 110. In an embodiment, the locking feature 114 (FIG. 3) engages the inner clutch to prevent the inner clutch from being inadvertently separated from the outer clutch 110. In block 204, a connector nut 151 (FIG. 7) is installed in the inner clutch 130. The connector nut 151 is retained in the inner clutch 130 by the flange 141 (FIGS. 1 and 4). In block 206, the outer clutch 110 is twisted, thus causing the inner clutch 130 to rotate and tighten the connector nut 151 onto its mating connector (not shown). The outer clutch 110 causes the inner clutch 130 to rotate until the twisting resistance of the inner clutch 130 causes the slip side 119 of the biased outer tooth 112 to impart sufficient force on the slip side 139 of the inner tooth 138 to cause the flexible portion 134 of the cantilevered inner member 132 to deflect. When the predetermined torque value is reached, the flexible portion 134 of the cantilevered inner member 132 deflects to the point that the slip side 119 of the biased outer tooth 112 slides over the slip side 139 of the inner tooth 138.

In block 208, further tightening of the inner clutch 130 is prevented and the flexible portion 134 snaps back with an audible sound or click, alerting the user that the predetermined torque value has been reached.

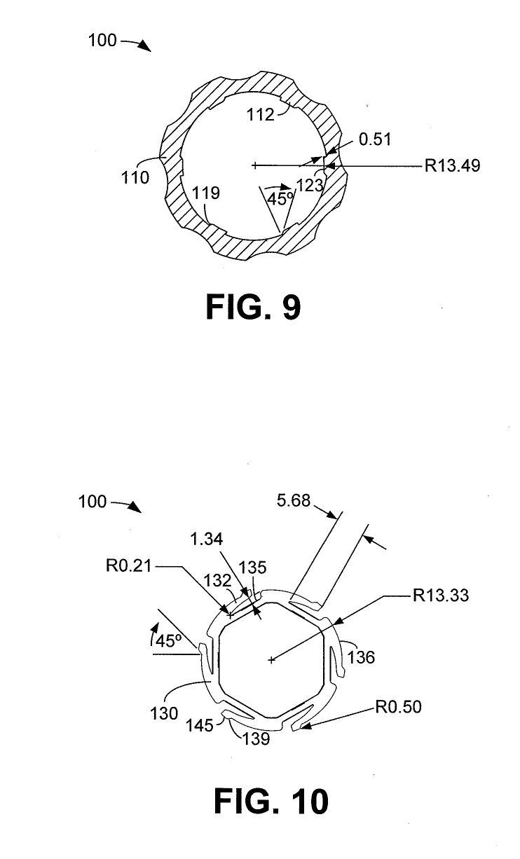

FIG. 9 is a plan view of the outer clutch 110, including exemplary dimensions. The dimensions shown in FIG. 9, and the figures to follow, are for exemplary purposes only and illustrate an embodiment of the torque-limiting connector 100. Other embodiments having dimensions different than the dimensions shown here are contemplated.

In an embodiment, the flat surface 123 of the biased outer tooth 112 is located at a radial dimension of approximately 13.49 millimeters (mm) from the center of the outer clutch 110. In this embodiment, the depth of the biased inner tooth 112 is approximately 0.51 mm. In an embodiment, the slip side 119 of the biased outer tooth forms an approximate 45 degree angle with respect to a line drawn through the center of the outer clutch 110.

FIG. 10 is a plan view of the inner clutch 130, including exemplary dimensions. In an embodiment, the region where the cantilevered inner member 132 meets the surface 135 forms a radius of approximately 0.21 mm. In an embodiment, the distance between a rear surface of the inner tooth 138 (FIG. 2) is approximately 1.34 mm from the surface 135. In an embodiment, the length of the cantilevered inner member 132 is approximately 5.68 mm. In an embodiment, the outer surface 136 of the inner clutch 130 is located at a radial dimension of approximately 13.33 mm from the center of the inner clutch 130. In an embodiment, the slip side 139 of the inner tooth 138 forms an approximate 45 degree angle with respect to a line drawn through the center of the inner clutch 130. In an embodiment, the region where the slip side 139 meets the surface 145 forms a radius of approximately 0.50 mm. The selection of the afore-mentioned dimensions influences the amount of torque that can be transferred from the outer clutch 110 to the inner clutch 130, and determines the torque applied to a connector.

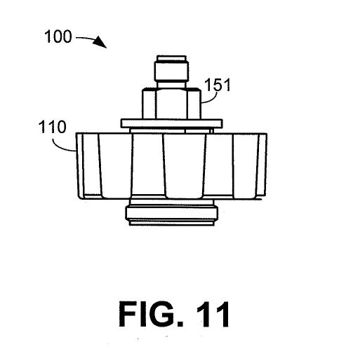

FIG. 11 is a profile view of the torque-limiting connector 100 including a connector nut 151 installed within the inner clutch 130. Although shown as being applicable to a connector nut 151, the torque-limiting connector 100 can be adapted to a variety of different fastener types including, but not limited to, a nut, a bolt, a screw, etc., and can be adapted to a variety of fastener drive types, such as, for example, hexagonal, Phillips, allen, torx, etc.

The foregoing detailed description has been given for understanding exemplary implementations of the invention and no unnecessary limitations should be understood therefrom as modifications will be obvious to those skilled in the art without departing from the scope of the appended claims and their equivalents.

What is claimed is:

1. A torque-limiting connector, comprising:
an outer clutch having a plurality of biased outer teeth; and
an inner clutch configured to fit within the outer clutch, the inner clutch having a plurality of cantilevered inner members, each of the plurality of cantilevered inner members having an inner tooth, wherein upon the application of a predetermined amount of torque, each of the plurality of biased outer teeth slips over a respective inner tooth.

2. The torque-limiting connector of claim 1, wherein each cantilevered inner member further comprises a flexible portion.

3. The torque-limiting connector of claim 2, wherein a degree of flexibility of the flexible portion determines the predetermined amount of torque.

4. The torque-limiting connector of claim 3, wherein the flexible portion is fabricated from a deformable plastic.

5. The torque-limiting connector of claim 1, wherein:
each of the plurality of biased outer teeth further comprises a drive side and a slip side;
each inner tooth further comprises a drive side and a slip side; and
wherein the slip side of the biased outer tooth slides over the slip side of the inner tooth when the predetermined amount of torque is applied to the outer clutch.

6. The torque-limiting connector of claim 1, wherein:
each biased outer tooth further comprises a drive side and a slip side;
each inner tooth further comprises a drive side and a slip side; and
wherein the drive side of the biased outer tooth contacts the drive side of the inner tooth when the outer clutch is rotated with respect to the inner clutch in a direction opposite a direction in which the predetermined amount of torque is applied.

7. The torque-limiting connector of claim 1, wherein the outer clutch further comprises a locking feature operative to prevent unintentional separation of the inner clutch and the outer clutch.

8. The torque-limiting connector of claim 1, wherein the inner clutch further comprises a flange operative to prevent unintentional separation of a connector nut and the inner clutch.

9. A torque-limiting connector, comprising:
an outer clutch having a plurality of biased outer teeth each of the plurality of biased outer teeth comprising a drive side and a slip side; and
an inner clutch configured to fit within the outer clutch, the inner clutch having a plurality of cantilevered inner members, each of the plurality of cantilevered inner members having an inner tooth, each inner tooth comprising a drive side and a slip side,
wherein upon the application of a predetermined amount of torque, each of the plurality of biased outer teeth slips over a respective inner tooth.

10. The torque-limiting connector of claim 9, wherein each cantilevered inner member further comprises a flexible portion.

11. The torque-limiting connector of claim 10, wherein a degree of flexibility of the flexible portion determines the predetermined amount of torque.

12. The torque-limiting connector of claim 11, wherein the flexible portion is fabricated from a deformable plastic.

13. The torque-limiting connector of claim 9, wherein the drive side of the biased outer tooth contacts the drive side of the inner tooth when the outer clutch is rotated with respect to the inner clutch in a direction opposite a direction in which the predetermined amount of torque is applied.

14. The torque-limiting connector of claim 9, wherein the outer clutch further comprises a locking feature operative to prevent unintentional separation of the inner clutch and the outer clutch.

15. The torque-limiting connector of claim 9, wherein the inner clutch further comprises a flange operative to prevent unintentional separation of a connector nut and the inner clutch.

16. A method for operating a torque-limiting connector, comprising:
attaching an inner clutch to an outer clutch such that the inner clutch rotates in the same direction as the outer clutch when a twisting force is applied to the outer clutch;
attaching a connector nut into the inner clutch;
twisting the outer clutch in a first direction to impart movement to the inner clutch, wherein the inner clutch rotates in the same direction as the outer clutch until a predetermined torque value is reached, after which a flexible portion of a cantilevered inner member deflects, thus preventing further movement of the inner clutch.

17. The method of claim 16, further comprising providing an audible indication when the predetermined torque value is reached.

18. The method of claim 16, further comprising twisting the outer clutch in a second direction, the second direction opposite the first direction, such that the flexible portion remains undeflected and the twisting motion in the second direction is imparted to the inner clutch.

19. The method of claim 16, wherein the inner clutch is releasably attached to the outer clutch.

20. The method of claim 16, further comprising forming the flexible portion of the cantilevered inner member from a deformable nylon material.
